(19) United States
(12) Patent Application Publication
(10) Pub. No.: US 2004/0169736 A1
(43) Pub. Date: Sep. 2, 2004

(54) Imaging method and system for associating images and metadata

(75) Inventors: Chrystie Rakvica, Fairport, NY (US); W. Wayne Didas, Webster, NY (US); James E. McGarvey, Hamlin, NY (US)

Correspondence Address: Milton S. Sales, Patent Legal Staff, Eastman Kodak Company, 343 State Street, Rochester, NY, 14650-2201, US

(73) Assignee: Eastman Kodak Company

(21) Appl. No.: 10/377,050

(22) Filed: Feb. 28, 2003

(51) Int. Cl. H04N 5/228

(52) U.S. Cl. 348/222.1

(57) ABSTRACT

In accordance with the present invention, an imaging system and method for operating an imaging system is provided. The imaging system has a metadata source adapted to generated a metadata signal in response to a manual metadata input action and a trigger system for generating a trigger signal in response to a trigger condition. An image capture system adapted to capture images is provided. A processor is operable to cause an image to be recorded only when the processor receives both a trigger signal and a metadata signal that uniquely correspond to the image.

### FIELD OF THE INVENTION

The invention relates to digital imaging systems of the type used to capture group and individual portrait images.

### BACKGROUND OF THE INVENTION

Professional photographers are often invited by organizations such as schools and athletic organizations to capture individual and group images of students and athletes. In these situations and in other similar photographic circumstances, it is particularly important for the photographer to properly associate each captured image with the student or athlete depicted in the image. Various systems have proposed to solve this problem.

In one currently used system, when a school requests that a photographer captures images of its students, the school will provide a database of information from the school with a record for each student. The photographer will then assign a unique number to each student for identification. Before going to the school to capture the images, the photographer will print out a camera card for each student with the student's name and a barcode of the student's unique identification and optionally other information. Information of this type is known as metadata. Metadata is a term that is used to describe any data that is associated with an image but may not necessarily visually appear in the image.

At the school, the student is provided with the camera card prepared for that student before the student's image is captured. The photographer will then write any package the student has ordered on the camera card, or attach the camera card to an order envelope that is also associated with the student. When the student's image is captured, the camera card is inserted into the camera such that the camera card is photographed at the same time the student's portrait is taken. The photographer will carefully keep the camera cards in the same order that the images are taken, thus tracking which student is associated with which image. Many known cameras are designed not to allow an image to be captured unless a camera card is inserted into the camera.

When the captured images are photofinished, an operator will carefully scan the barcode from each camera card into their system in the order that the pictures were taken. Frequently, the metadata from the card is added to the data for each frame, thus indicating which subject data record is associated with the film frame. Sometimes the subject data record is modified to indicate the sequence order the student's portrait was taken.

The problem with this system is that if the camera cards become out of order, for example where a card is dropped, not placed on the pile, where two cards stick together, or where the cards otherwise deviate from the order in which images are taken, the wrong student will be assigned to the wrong image, students will receive the wrong packages, student IDs will have the wrong names, etc. This can lead to delays, reprints and customer dissatisfaction.

To prevent this, certain photographers digitally scan captured images, and use another software application to compare the subject information on the camera cards to the subject record recorded on each frame. This system will usually display each frame, with the optically captured portion of the camera card, along with the subject data record that has been assigned to it. By viewing the camera card info and the student data info, an operator can verify that the correct student data is assigned to the correct image. The operator usually has the ability to insert subject data records, adjust the images to data records, and search for a specific students record to fix the data. Given that there are often over 1000 students associated with a school, and the photographer is handling many schools, this operation is very time consuming. Accordingly, many photographers and photographic studios only perform a spot check on the data, and do not verify every frame.

Other camera systems have also been proposed that record the metadata in association with the image itself. One example of a camera system that can be used in such a system is described in U.S. Pat. No. 4,422,745 entitled “Camera System” filed by Hopson on Jul. 31, 1981. In the camera system that is described therein, a microprocessor controlled camera system is provided for exposing film with a photographic object, a field of barcode data relevant to the subject, and a field of data taken from a written card. This camera system has an area for receiving a card having bar coded or other information record thereon. In a preferred embodiment, means are provided for adding bar code information on one data track of the film and written information obtained from a data card on a another track of the film, with both data tracks on opposite sides of the film image. The camera has a card reader for detecting whether a coded card containing information has been inserted into the camera and is adapted with control logic that prevents the shutter from opening unless a camera card is inserted. In a preferred embodiment of the '745 patent, customer order information is entered either through a card reader device or a keyboard in order to enable the shutter to trip.

Commonly assigned U.S. Pat. No. 5,965,859 entitled “Automated system and method for associating identification data with images” filed on Feb. 19, 1997 by DiVincenzo et al. describes a system for automatically associating the user-generated data to images. The system comprises a card reader device that receives and recognizes the user-generated data entered directly from manipulation of the terminal by a user. A camera captures an image and receives data from the card reader device for associating a captured image in the data for forming a labeled image. In this system, a user is provided with a card having a magnetic stripe with metadata encoded thereon including user identification information. Whenever a photographer takes a user's picture, the user swipes the card, and their unique ID is written in the metadata of the image. In one embodiment of this patent, software is initiated upon activation of the camera, and directs any incoming data from the card reader to be stored in a memory. After capture of an image, software continuously inputs or copies the data from the memory to the header on the file of the most recently captured image until new incoming data is received. This system is both commercially viable and useful for its intended purpose.

However, under certain photographic circumstances, it can be useful to invoke greater interaction between the photographer and the camera in order to ensure that metadata is properly recorded in association with each captured image.

### SUMMARY OF THE INVENTION

In accordance with one embodiment of the present invention, an imaging system is provided. The imaging system has a metadata source adapted to generate a metadata signal in response to manual metadata input action and a trigger system for generating a trigger signal in response to a trigger condition. An image capture system adapted to capture images and a processor are provided. The processor is operable to cause an image to be recorded only when the processor receives both a trigger signal and a metadata signal that uniquely correspond to the image.

In accordance with another embodiment, an imaging system is provided having a metadata source adapted to sense available metadata in response to manual user input action and to store sensed metadata in a buffer. A trigger system for generating trigger signals and an image capture system adapted to capture images are provided. A processor is provided. The processor is adapted to receive each trigger signal and to cause an image to be recorded in response to the trigger signal only when metadata is in the buffer, wherein the processor removes metadata from the buffer after each image is recorded.

In another embodiment, a method for operating an imaging system is provided. In accordance with the method available metadata is sensed in response to a manual user input and available metadata is stored in a buffer. Trigger conditions are detected and an image is recorded in response to each detected trigger condition only when metadata is in the buffer. Metadata is removed from the buffer after each image is recorded.

### BRIEF DESCRIPTION OF THE DRAWINGS

FIG. 1 shows one embodiment of an imaging system in accordance with the present invention.

FIG. 2 shows a back view of one embodiment of the imaging system of FIG. 1 and an associated metadata source.

FIG. 3 shows a remote control device that can optionally be used in conjunction with the present invention;

FIG. 4 shows one embodiment metadata token containing various forms of metadata that can be sensed by a metadata source.

FIG. 5 shows one embodiment of a method in accordance with the present invention.

FIG. 6 shows another embodiment of a method in accordance with the present invention.

FIG. 7 shows still another embodiment of a method in accordance with the present invention.

### DETAILED DESCRIPTION OF THE INVENTION

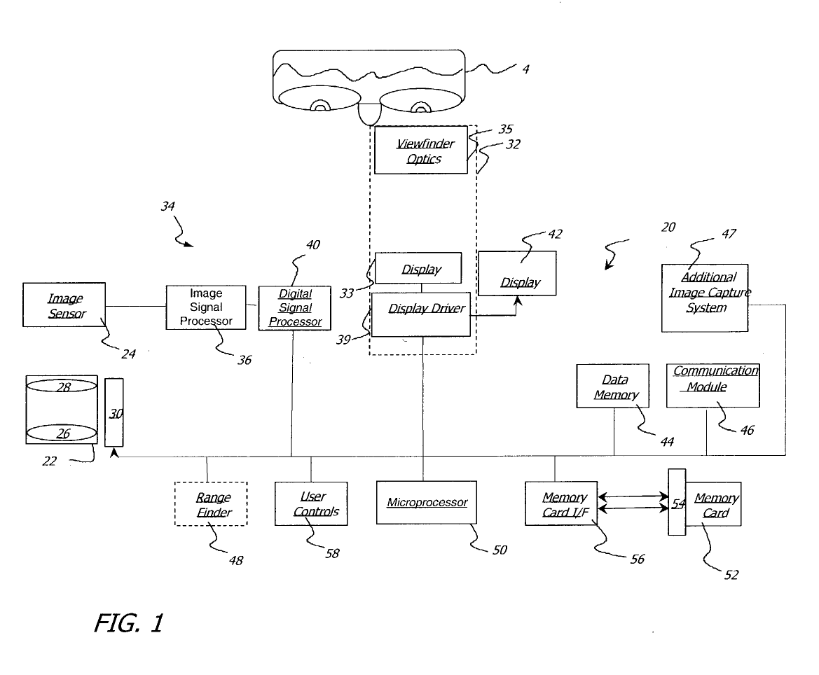

FIG. 1 shows a block diagram of an embodiment of an imaging system 20 for capturing digital images. As is shown in FIG. 1, imaging system 20 includes a taking lens unit 22, which directs light from a subject (not shown) to form an image on an image sensor 24.

The taking lens unit 22 can be simple, such as having a single focal length with manual focusing or a fixed focus. In the example embodiment shown in FIG. 1, taking lens unit 22 is a motorized 2× zoom lens unit in which a mobile element or combination of elements 26 are driven, relative to a stationary element or combination of elements 28 by a lens driver 30. Lens driver 30 controls both the lens focal length and the lens focus position of taking lens unit 22 by controlled adjustment of element or elements 26.

Lens driver 30 is controlled by signals generated by a microprocessor 50. Said signals intended to achieve settings that are either manually input into imaging system 20 by way of user controls 58 or that are automatically determined. Various methods can be used to automatically determine focus settings for taking lens unit 22. In one embodiment, image sensor 24 is used to provide at least one image prior to capture of an archival image from which digital signal processor 40 and microprocessor 50 can determine optimum settings for taking lens unit 22. Various conventional techniques can be used to extract lens settings from such an image including but not limited to converting the image into a frequency space and determining a focus setting, using interpolation, whole way scanning and through focusing techniques. Alternatively, imaging system 20 can use a separate optical or other type (e.g. ultrasonic) rangefinder 48 such as a single or multi-spot, active or passive rangefinder as are know in the art to identify the subject of the image and to select a focus position for taking lens unit 22 that is appropriate for the distance to the subject and to provide signals to operate lens driver 30. In the embodiment of FIG. 1, a feedback loop is established between lens driver 30 and microprocessor 50 so that microprocessor 50 can accurately set the focal length and the lens focus position of taking lens unit 22.

Light that is focused by taking lens unit 22 forms an image at image sensor 24 of an image capture system 34. Image sensor 24 can comprise any known array of photosensitive sites (not shown) such as a conventional Charge Couple Device (CCD), Complimentary Metal Oxide sensor (CMOS) or Charge Injection Device (CID). When microprocessor 50 determines that an image is to be captured, microprocessor 50 transmits a signal to image signal processor 36 which causes the photosensitive sites to collect charge using light that strikes image sensor 24 during a period of time known as an integration time. Image signal processor 36 collects charge signals from image sensor 24 indicative of the amount of charge received at each photosensitive site during the integration time and converts the charge signals into a digital data that is representative of the image formed at image sensor 24. In this regard, image signal processor 36 can comprise one or more amplifiers, analog signal processors, analog to digital converters, memory and/or control logic circuits in order to perform the conversion. Such circuits are known in the art. The digital image data generated by image signal processor 36 is provided to digital signal processor 40.

Digital signal processor 40 applies conventional algorithms to convert the received digital data to create archival images of the scene. Archival images are typically high resolution images suitable for storage, reproduction, and sharing. Archival images are optionally compressed using the JPEG (Joint Photographic Experts Group) ISO 10918-1 (ITU—T.81) standard. The JPEG compression standard uses the well-known discrete cosine transform to transform 8×8 blocks of luminance and chrominance signals into the spatial frequency domain. These discrete cosine transform coefficients are then quantized and entropy coded to produce JPEG compressed image data. This JPEG compressed image data is stored using the so-called “Exif” image format defined in the Exchangeable Image File Format version 2.2 published by the Japan Electronics and Information Technology Industries Association JEITA CP-3451. Other image processing and compression algorithms can also be used.

The archival image can be stored in data memory 44. The archival image can also be stored in a removable memory card 52. In the embodiment of FIG. 1, imaging system 20 is shown having a memory card slot 54 that holds memory card 52 and has a memory card interface 56 for communicating with memory card 52. An archival image and any other digital data can also be transmitted to a host computer or other device (not shown), which is connected to imaging system 20 through a communication module 46.

Communication module 46 can take many known forms. For example, any known optical, radio frequency or other transducer can be used. Such transducers convert image and other data into a form such as an optical signal, radio frequency signal or other form of signal that can be conveyed by way of a wireless, wired or optical network such as a cellular, satellite, cable, telecommunication network, the internet (not shown) or other communication path to a host computer or other device, including but not limited to, a printer, internet appliance, personal digital assistant, telephone or television.

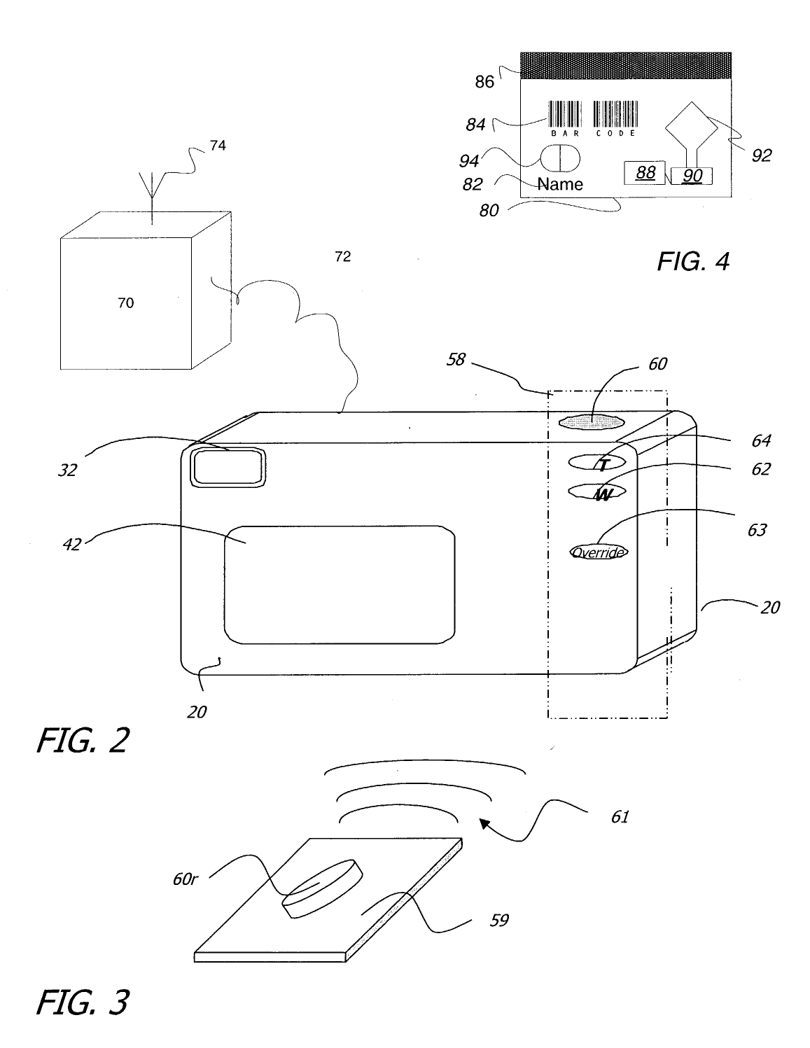

Digital signal processor 40 also creates smaller size digital images based upon the digital image data received from image signal processor 30. These smaller sized images are referred to herein as evaluation images. Typically, the evaluation images are lower resolution images adapted for display on viewfinder system 32 having a viewfinder display 33 and associated viewfinder options or on exterior display 42. Viewfinder display 33 and exterior display 42 can comprise, for example, a color or gray scale liquid crystal display (LCD), organic light emitting display (OLED) also known as an organic electroluminescent display (OELD); a subset of the OLED type display that uses polymeric compounds to emit light (also known as PLED), or other type of video display can also be used. In the embodiment of FIG. 2, a display driver 39 receives signals from digital signal processor 40 and/or microprocessor 50 and provides these signals into control signals that operate viewfinder display 33 and exterior display 42.

In an image capture sequence, digital signal processor 40 can use the digital image data to generate evaluation images, archival images, or both. As used herein, the term “image capture sequence” can comprise at least an image capture phase. An optional composition phase and a verification phase can also be provided.

During the composition phase, microprocessor 50 sends signals to image signal processor 36 that cause image sensor 24 to repeatedly capture charge at the photosensitive sites and provide charge signals that image signal processor 36 converts into digital data. This forms a stream of digital image data which is provided to digital signal processor 40 and further processed to create a stream of evaluation images based upon the initial images. The stream of evaluation images is presented on viewfinder display 33 or exterior display 42. User 4 observes the stream of evaluation images and uses the evaluation images to compose an archival image. The evaluation images can be created as described using, for example, resampling techniques such as are described in commonly assigned U.S. Pat. No. 5,164,831 entitled “Electronic Still Camera Providing Multi-Format Storage Of Full And Reduced Resolution Images” filed by Kuchta et al., on Mar. 15, 1990, the disclosure of which is herein incorporated by reference. The evaluation images can also be stored, for example, in data memory 44, memory card 52 or transmitted to a separate device using communication module 46.

During the capture phase, microprocessor 50 sends a capture signal causing digital signal processor 40 to obtain digital image data from image signal processor 36 and to process the digital image data to form an archival image. The capture phase is typically initiated when microprocessor detects a trigger condition as will be described in greater detail below. In this regard, microprocessor 50 and any other device that co-operates with trigger microprocessor 50 to determine a trigger condition comprise a trigger system.

During the verification phase, an evaluation image having an appearance that corresponds to the archival image can also be formed. This evaluation image can be formed based upon the digital image data directly or it can be formed based upon the archival image. The corresponding evaluation image is adapted for presentation on a display such as viewfinder display 33 or exterior display 42. The corresponding evaluation image is supplied to viewfinder display 33 or exterior display 42 and is presented for a period of time. This permits user 4 to verify that the appearance of the captured archival image is acceptable.

In an alternative embodiment, imaging system 20 has more than one system for capturing images. For example, in FIG. 1 an optional additional image capture system 47 is shown. This additional image capture system 47 can be used for capturing archival images. The additional image capture system 47 can comprise an image capture system that records images using a high resolution digital imager or a photographic element such as film or a plate (not shown). Where an additional image capture system 47 is used, microprocessor 50 causes image signal processor 36 to capture digital image data from image sensor 24 at a time that is generally consistent with the time that the image is captured by an additional image capture system 47. Microprocessor 50 then causes digital signal processor 40 to process the digital image data in a way that is expected to form an evaluation image that has an appearance that conforms to the appearance of an image captured by the additional image capture system 47.

Imaging system 20 is controlled by user controls 58, some of which are shown in more detail in FIG. 2. User controls 58 can comprise any form of transducer or other device capable of receiving input from user 4 and converting this input into a form that can be used by microprocessor 50 in operating imaging system 20. For example, user controls 58 can include but are not limited to touch screens, four-way, six-way, eight-way rocker switches, joysticks, styluses, track balls, voice recognition systems, gesture recognition systems and other such systems.

In the embodiment shown in FIG. 2, user controls 58 include shutter trigger button 60. User 4 indicates a desire to capture an image by depressing shutter trigger button 60. This causes a trigger signal to be transmitted to microprocessor 50. Microprocessor 50 receives the trigger signal and generates a capture signal in response to the trigger signal as will be described in greater detail below. Image signal processor 36 obtains digital image data from image sensor 24 in response to the capture signal.

Shutter trigger button 60 can be fixed to imaging system 20 as is shown in FIG. 2. Optionally, as is shown in FIG. 3, a remote control device 59 can be provided. Remote control device 59 has a remote shutter trigger button 60r. Remote control device 59 reacts to the depression of remote shutter trigger button 60r by transmitting a control signal 61 to imaging system 20. When communication module 46 detects the transmitted control signal 61, communication module 46 transmits a trigger signal to microprocessor 50. Remote control device 59 can transmit control signal 61 to imaging system 20 using wireless communication systems or wired communication paths, optical communication paths or other physical connections. Microprocessor 50 responds to the trigger signal by transmitting a capture signal as is described above. Microprocessor 50 can also generate a capture signal in response to other detected stimuli such as in response to an internal or external clocking system or detected movement in the scene.

Other user controls 58 can likewise be mounted on remote control device 59. Remote control device 59 can be a dedicated remote control device and can also take many other forms, for example, any cellular telephone, a personal digital assistant, or a personal computer.

In the embodiment shown in FIG. 2, user controls 58 include a “wide” zoom lens button 62 and a “tele” zoom lens button 64, that together control both a 2:1 optical zoom and a 2:1 digital zoom feature. The optical zoom is provided by taking lens unit 22, and adjusts the magnification in order to change the field of view of the focal plane image captured by image sensor 24. The digital zoom is provided by digital signal processor 40, which crops and resamples the captured image stored in frame memory 38 when the digital zoom is active.

As is shown in FIG. 2, imaging system 20 further comprises a metadata source 70 that is adapted to obtain metadata from a metadata token 80 which can, for example, take the form of a card shown in FIG. 4. The metadata token 80 of FIG. 4 contains metadata that is recorded in the form of written text 82 and a written bar code 84. Metadata source 70 can comprise a scanner or other optical imaging system having an optical sensor that can optically derive metadata from written text 82 and/or the optically written bar code 84. In other embodiments, metadata can be encoded on metadata token 80 by writing such metadata on a magnetic strip 86, by encoding metadata in patterns of raised and lowered areas (not shown) on metadata token 80, or by otherwise encoding metadata on metadata token 80. In such embodiments, metadata source 70 is co-designed with sensors that are adapted to detect such encoded metadata.

Alternatively, metadata can be stored in metadata token 80 in an electronic form using for example a memory 88. Metadata can be received from and/or stored in memory 88 by associating a radio frequency transponder 90 and antenna 92 with memory 88. Where metadata token 80 has memory 88/radio frequency transponder 90/antenna 92 arrangement, metadata source 70 can comprise an transceiver (not shown) for transmitting a first electromagnetic field that is received by the radio frequency transponder 90 and which causes radio frequency transponder 90 to generate a second magnetic field containing metadata. The transceiver detects second electromagnetic field and extracts metadata from the second electromagnetic field. Metadata token 80 can alternatively have a memory with contacts 94 that permit direct electrical engagement between contacts 94 and metadata source 70 to permit data to be exchanged between metadata source 70 and memory 88. It will be appreciated that metadata token 80 has been shown as having multiple types of metadata associated therewith, it is only needed for metadata token 80 to have one type of metadata that can be sensed.

In other useful embodiments of the present invention, metadata can be extracted from a scene using image information that is captured by imaging system 20. In this regard, metadata token 80 can be positioned in an image or can be separately imaged, with digital signal processor 40 being adapted to extract image information from the image of metadata token 80. Additionally, it will be appreciated that the present invention can be performed without the use of metadata token 80, for example, any of user controls 58 can also be used to receive metadata by way of a manual metadata input action. Similarly metadata can be written or otherwise encoded in the scene.

It can also be useful to permit a manual metadata input action that permits user 4 to indicate a desire for stored metadata to be used. For example, in the embodiment of FIG. 2, an override button 63 is provided. When user 4 depresses override button 63, microprocessor 50 determines that a manual metadata input action has occurred and obtains stored data for use as metadata for an image. This stored metadata can comprise but is not limited to metadata from the last image captured by imaging system 20, preprogrammed metadata, time and date metadata, other data or a null data set.

Metadata source 70 is adapted to generate a separate metadata signal each time user 4 makes a manual metadata input action. Where metadata source 70 senses metadata that is recorded on metadata token 80, any user action that positions metadata token 80 so that metadata source 70 can obtain metadata from metadata token 80 can constitute a manual metadata input action. Similarly any user action that directs metadata source 70 to read metadata from a particular metadata token 80 can also comprise a user input action. Where metadata is extracted from the scene image, the placement of metadata in a scene can constitute a manual metadata input action.

The metadata input action can comprise a single action or it can comprise multiple actions. The metadata input action may require user 4 to provide metadata from multiple portions of metadata token, or to scan multiple bar codes in order to, for example, build an association between student, class room and school. As used herein the term manual metadata input action includes multiple actions as well as action. Similarly, the term metadata signal as used herein can include any or all of the metadata to be associated with an image regardless of the number of actions in the manual metadata input action.

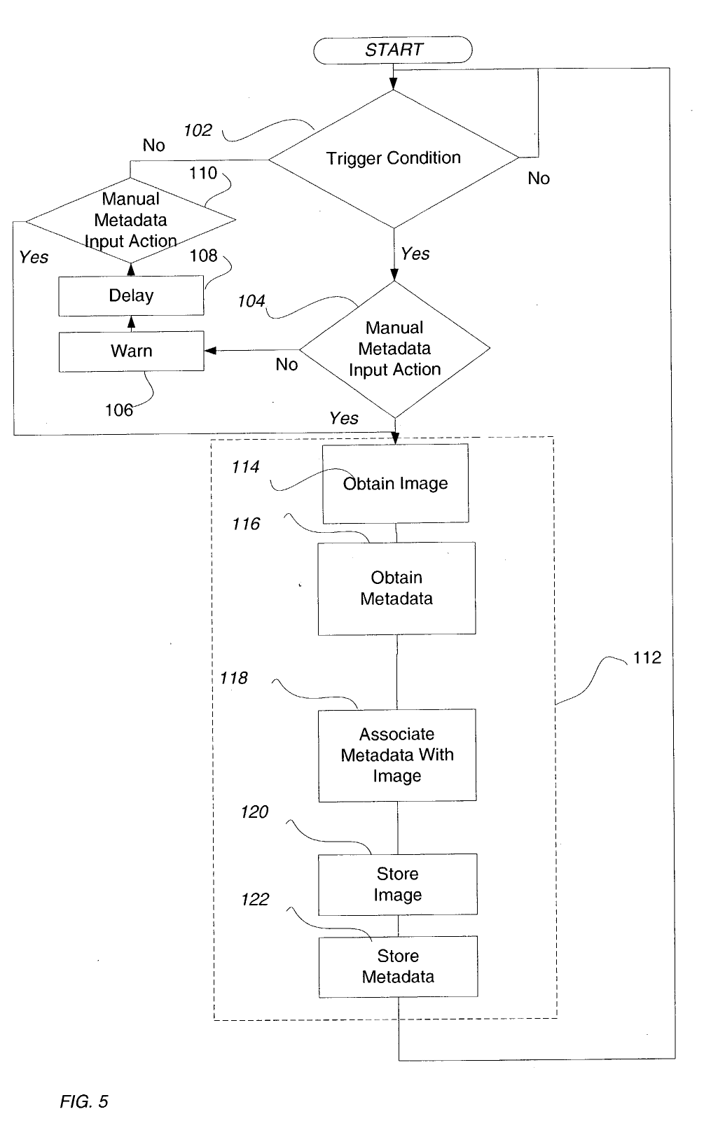

FIG. 5 shows a flow diagram depicting one embodiment of a method in accordance with the present invention. As is shown in FIG. 5, in this embodiment, microprocessor 50 determines whether a trigger condition exists that uniquely corresponds with an image to be captured (step 102). As is described above, any of a number of trigger conditions is possible. One example of such a trigger condition is the depression of shutter trigger button 60. Each time shutter trigger button 60 is depressed, a separate trigger signal is generated. In this example, when microprocessor 50 detects a separate trigger signal, microprocessor 50 can determine that a trigger condition exists. Each trigger signal uniquely corresponds with an image in that each trigger signal occasions only one opportunity for an image to be recorded. Where an image is not recorded in response to a trigger condition, then microprocessor 50 either requires another trigger signal before recording an image.

Microprocessor 50 then determines whether user 4 has performed a manual metadata input action (step 104) that uniquely corresponds with the image to be captured. Microprocessor 50 can make this determination based upon whether a separate metadata signal has been received before the trigger condition is detected. Where no metadata signal has been received, microprocessor 50 continues to detect separate trigger signals or otherwise continues to determine whether other trigger conditions occur (step 102).

Optionally, as is shown in FIG. 5, microprocessor 50 can provide an opportunity for user 4 to perform a manual metadata input action after the trigger signal is received. As is shown in FIG. 5, this can be done by causing microprocessor 50 to provide an optional warning (step 106) and delay for a period of time (step 108). This warning can comprise, for example, a warning message displayed on exterior display 42. This warning can also comprise a failure of microprocessor 50 to present an evaluation image within an expected period of time after shutter trigger button 60 has been depressed or a trigger signal has otherwise been generated. The delay period allows user 4 to perform a manual metadata input action. At the end of the delay, microprocessor 50 optionally again determines whether a manual metadata input action has occurred (step 110). In the embodiment shown, where a separate metadata input action is not provided within the period of the wait time, microprocessor 50 returns to the step of detecting a new trigger condition (step 102).

Where a separate trigger condition and a separate metadata input action are detected that uniquely correspond to an image, microprocessor 50 performs an image recording step (step 112). The image recording step (step 112) comprises at least the steps of capturing an image (step 114) and storing the image (step 120). These steps are preformed as described above.

As is shown in FIG. 5, the image recording step (step 112) can also include the step of obtaining metadata (step 116), associating the metadata with the archival image (step 118), and storing the metadata (step 120). Metadata can be obtained (step 116) by receiving the metadata signal or by receiving and processing the metadata signal to derive metadata from the metadata signal. The obtained metadata can be associated with the archival image (step 118) in a number of ways, for example, the obtained metadata can be stored in a header file in the archival image (step 122). Similarly, the metadata can be recorded in the archival image for example using visible or essentially invisible metadata encodement schemes known in the art. Alternatively, it can be determined that the metadata is to be stored in an accessible memory and an association can be built between the archival image and the metadata by recording information in the archival image that can be used to locate and obtain the stored metadata.

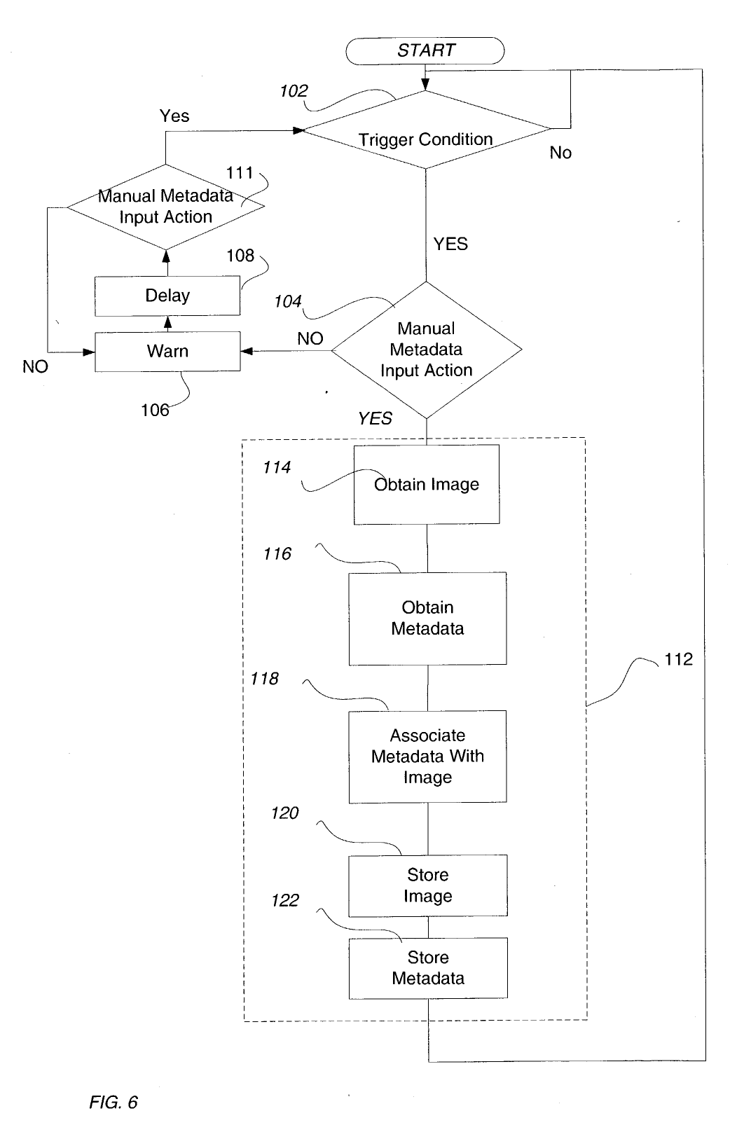

An alternative embodiment is shown in FIG. 6, in this embodiment, when microprocessor 50 determines that a trigger condition exists that uniquely corresponds to an image (step 102) but that no manual metadata input action has occurred that uniquely corresponds to the image (step 104) microprocessor 50 optionally executes a warning (step 106) and a delay (step 108) to permit a user time to perform a user input action. In this embodiment, user 4 can respond to the warning by making a manual metadata input action such as by depressing the override button 63 shown in FIG. 2 so that the next time that microprocessor 50 determines that a trigger condition exists (step 102) microprocessor 50 can also determine that a manual metadata input action has occurred that is uniquely associated with an image (step 104) and can proceed to the recording step (step 112). However, where the manual metadata input action comprises depression of override button 63, microprocessor 50 performs the optional step of obtaining metadata (step 116) by obtaining stored metadata for use as a metadata signal.

In the embodiment of FIG. 6, an optional step of determining whether a manual metadata input action has occurred (step 111) is also shown. Where this optional step is used, microprocessor 50 repeats the warning and delay steps (step 106 and 108) when a manual metadata input action does not occur within the delay period and microprocessor 50 does not return the process to the step of determining whether a trigger signal has been detected (step 102) unless a manual metadata input action occurs.

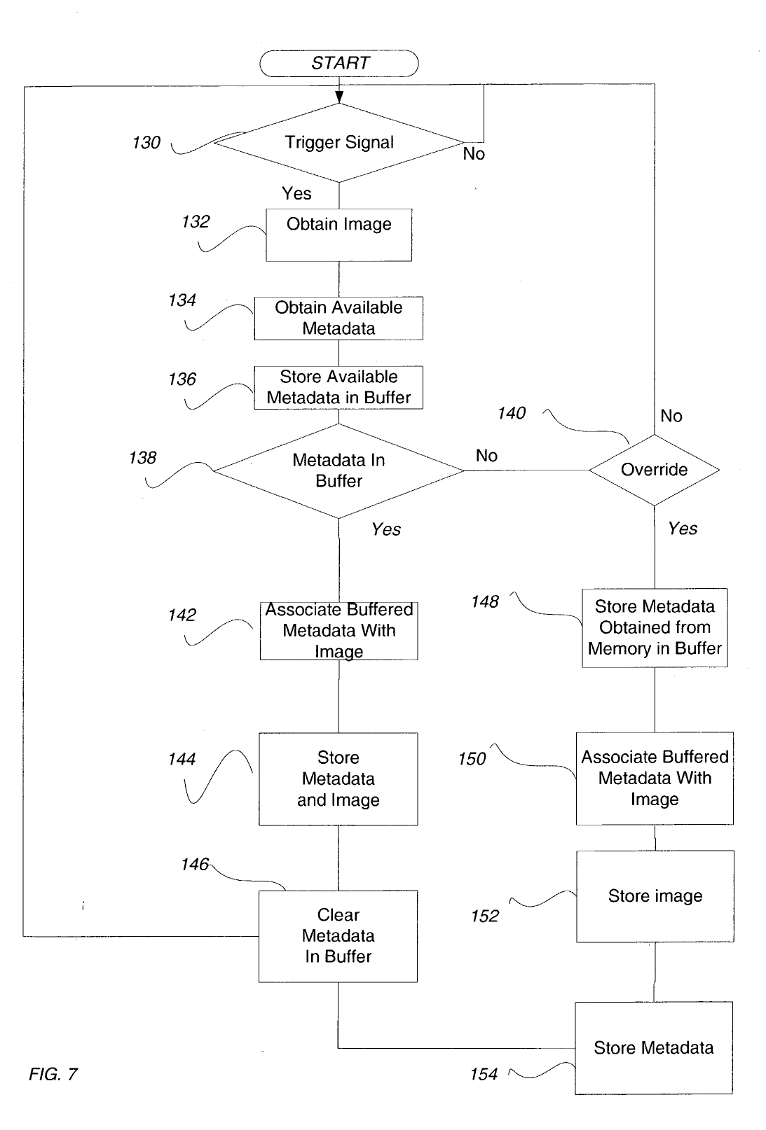

FIG. 7 shows another embodiment of the present invention. In this embodiment, a trigger signal is detected for example, in response to a trigger signal generated as described above (step 130). In response, microprocessor 50 captures an image (step 132). In this embodiment, metadata source 70 detects when metadata is made available by way of a manual metadata input such as positioning metadata token 80 in proximity to a reading device, obtains the metadata (step 134) and stores such metadata in a buffer (step 136).

Microprocessor 50 polls the buffer to determine whether any metadata is in the buffer (step 138). Where no metadata is in the buffer, microprocessor 50 returns to the step of detecting a trigger signal (step 130). In this way, the presence of metadata in the buffer acts as a flag, where no metadata is found in the buffer when a trigger signal is provided then no image is recorded in response to the trigger signal. However, in the embodiment of FIG. 7, when metadata is found in the buffer, microprocessor 50 performs the functions of associating the buffered metadata with the captured image (step 142) and storing the metadata in the image (step 144). These steps can be performed generally as is described above. However, in this embodiment an additional step is then performed, the step of clearing metadata in the buffer (step 146). By clearing the metadata in the buffer, after the metadata has been stored in association with the image, the buffer is readied for use when microprocessor 50 returns to the step of detecting the next trigger signal (step 130).

Where no metadata is in the buffer (step 138) however, microprocessor 50 can return to the step of determining whether a trigger condition exists, as is shown in the embodiment of FIG. 7, microprocessor 50 can also perform the step of detecting an override input (step 140). Where no such override signal is detected microprocessor 50 returns to step 130 of detecting a trigger signal. However, where such override signal is detected, previously stored metadata can be obtained from a memory such as data memory 44 and inserted into the buffer (step 148). The buffered metadata can then be associated with the image as is described above (step 150). As is also described above, the steps of storing the image (step 152) and optionally storing the metadata (step 154) can then be performed. However, it will be appreciated that as the metadata is already stored, it may be possible to omit the step of storing the metadata (step 154).

The invention has been described in detail with particular reference to certain preferred embodiments thereof, but it will be understood that variations and modifications can be effected within the spirit and scope of the invention.

### Parts List

4 user

20 imaging system

22 taking lens unit

24 image sensor

26 element

28 element

30 lens driver

32 viewfinder system

33 viewfinder display

34 image capture system

35 viewfinder optics

36 image signal processor

38 frame memory

39 display driver

40 digital signal processor

42 exterior display

44 data memory

46 communication module

47 additional image capture system

48 rangefinder

50 microprocessor

52 memory card

54 memory card slot

56 memory card interface

58 user controls

59 remote control device

60 shutter trigger button

60r remote shutter trigger button

61 control signal

62 “wide” zoom lens button

63 override button

64 “tele” zoom lens button

70 metadata source

74 antenna

80 metadata token

82 written text

84 optically written bar code

86 magnetic strip

88 memory

90 radio frequency transponder

92 antenna

94 contacts

102 detect separate trigger condition step

104 manual metadata input action determining step

106 delay step

108 warning step

110 detect manual metadata input action step

111 detect manual metadata input action step

112 record image step

114 capture image step

116 obtain metadata step

118 associate metadata with image step

120 store image step

122 store metadata step

124 override determining step

126 receive stored metadata step

130 detect trigger signal step

132 capture image step

134 obtain available metadata step

136 store available metadata in buffer step

138 metadata stored in buffer determining step

140 override signal detected step

142 associate buffered metadata with image step

144 store metadata and image step

146 clear metadata in buffer step

148 store metadata obtained from memory in buffer

150 associate buffered metadata with image step

152 store image step

154 store metadata step

What is claimed is:

1. An imaging system, comprising:
a metadata source adapted to generate a metadata signal in response to a manual metadata input action;
a trigger system for generating a trigger signal in response to a trigger condition;
an image capture system adapted to capture images; and
a processor operable to cause an image to be recorded only when the processor receives both a trigger signal and a metadata signal that uniquely correspond to the image.

2. The imaging system of claim 1, wherein said processor is adapted to record an image by causing the image capture system to capture an image and to store the image.

3. The imaging system of claim 1, wherein said processor is adapted to record an image by causing the image capture system to capture an image, associating the metadata signal with the captured image, and storing the image and the associated metadata signal.

4. The imaging system of claim 1, wherein the processor is adapted to record an image by causing the image capture system to capture an image, to derive metadata from the metadata signal, to associate the image and the extracted metadata, and to store the image and extracted metadata.

5. The imaging system of claim 1 wherein said processor is adapted to record an image by causing the image capture system to capture an image, associating the metadata with the captured image and storing the image in one memory and the metadata in a different memory.

6. The imaging system of claim 1, wherein the metadata source comprises a sensor that automatically senses metadata from a metadata token and provides a metadata signal in response to a manual metadata input action directing the metadata source to read metadata from the metadata token.

7. The imaging system of claim 1, wherein the metadata source comprises a sensor that automatically senses metadata from a metadata token positioned at a location and provides a metadata signal in response to a manual metadata input action of positioning the metadata token at the location and wherein the metadata input action comprises positioning the metadata token at the location.

8. The imaging system of claim 1, wherein the metadata source comprises a sensor that automatically senses metadata from a metadata token moved through a series of locations and provides a metadata signal containing metadata when the metadata token is manually moved through the series of locations and wherein the manual metadata input action comprises moving the metadata token through a series of locations.

9. The imaging system of claim 1, wherein the metadata source comprises a sensor system for extracting metadata from a metadata token using at least one of an optical, electrical, electromechanical, and radio frequency sensor.

10. The imaging system of claim 1, wherein the metadata source comprises the image capture system and the processor, wherein the processor is adapted to analyze at least one image captured by the image capture system, to detect metadata input actions based upon analysis of the at least one image and to generate a metadata signal based upon analysis of the at least one image.

11. The imaging system of claim 1, further comprising user controls adapted to receive a user input and to generate an input signal, wherein the processor is further adapted to detect a user input after a separate trigger signal is received without a separate metadata signal, and wherein said processor obtains a stored metadata signal and uses the stored metadata as a metadata signal that uniquely corresponds to an image to be recorded signal when the processor detects the user input signal in response to the request for user input.

12. The imaging system of claim 1, wherein the metadata source comprises user controls adapted to receive a manual input action and to convert the manual input action into a metadata signal.

13. An imaging system comprising:
a metadata source adapted to sense available metadata in response to a manual user input action and to store sensed metadata in a buffer;
a trigger system for generating trigger signals;
an image capture system adapted to capture images; and
a processor adapted to receive each trigger signal and cause an image to be recorded in response to the trigger signal only when metadata is in the buffer,
wherein the processor removes metadata from the buffer after each image is recorded.

14. The imaging system of claim 13, wherein the processor stores removed metadata in a memory.

15. The imaging system of claim 13, further comprising user controls adapted to receive a user input and to generate a control signal, wherein the processor is adapted to receive the control signal after the trigger signal and to move metadata from the memory into the buffer in response to the control signal so that the processor can record an image.

16. The imaging system of claim 13, wherein the processor causes an image to be recorded by causing the image capture system to capture an image, associating the image and the metadata that is stored in the buffer and storing the image and the metadata in a memory.

17. The imaging system of claim 13, wherein the processor causes an image to be recorded by the image capture system to capture an image, to associate the image and the metadata in the buffer, and to store the metadata in a first memory and the image in a second memory.

18. A method for operating an imaging system, the method comprising the steps of:
detecting a manual metadata input action and generating metadata in response thereto;
detecting a trigger condition, and,
recording an image only when both of a separate manual metadata input action and separate trigger condition are detected that uniquely correspond the image.

19. The method of claim 18, wherein the step of recording an image comprises capturing an image and storing the image.

20. The method of claim 18, wherein the step of recording an image comprises capturing an image, associating the metadata with the captured image, and storing the captured image and the metadata.

21. The method of claim 18, wherein the step of recording an image comprises capturing an image, to extracting selected portions of metadata from the metadata and to associate the image and extracted portions of metadata, and storing the image and extracted portions of metadata.

22. The method of claim 18 wherein the step of recording an image comprises capturing an image associating, metadata with the captured image and storing the image apart from the metadata.

23. The method of claim 18, wherein the metadata is generated by sensing metadata from a metadata token having metadata and wherein said metadata is sensed in response to a manual metadata input action comprising directing a sensor to sense metadata from the metadata token.

24. The method of claim 18, wherein the metadata is generated by sensing metadata from a metadata token that is positioned in a sensing area and wherein the manual metadata input action comprises presenting a metadata token having metadata in the sensing area.

25. The method of claim 18, wherein the metadata is generated by a sensor that detects when a metadata token having metadata is moved through a series of locations and that automatically provides metadata when the metadata token is manually moved through the series of locations and wherein the manual metadata input action comprises positioning the metadata token at the location.

26. The method of claim 18, wherein the step of generating a metadata signal comprises sensing metadata from metadata token having metadata that is detectable using one of an optical, electrical, electromechanical, and radio frequency sensor.

27. The method of claim 18, wherein the step of obtaining metadata comprises capturing at least one image and the step of detecting a manual metadata input action and generating metadata in response thereto comprises detecting a manual metadata input action based upon analysis of the at least one image and generating metadata based upon analysis of the at least one image.

28. The method of claim 18, further comprising the step of storing metadata signals, detecting a metadata input action after a trigger condition is detected without a separate manual metadata input action, detecting a manual metadata input action, receiving the manual metadata input action and, in response to the metadata input action using stored metadata as metadata that uniquely corresponds to the image.

29. The method of claim 18, wherein the step of detecting a manual metadata input action and generating metadata in response thereto comprises detecting a manual input action and converting the manual input action into metadata

30. The method of claim 18, wherein an image is captured in response to each trigger signal, however, the captured image is recorded only when both of a separate manual metadata input action and separate trigger condition are detected that uniquely correspond the image.

31. An method for operating an imaging system, the method comprising the steps of:
sensing available metadata in response to a manual user input;
storing available metadata in a buffer;
detecting trigger conditions; and
recording an image in response to each detected trigger condition only when metadata is in the buffer; and,
removing metadata from the buffer after each image is recorded.

32. The method of claim 31, further comprising the step of storing metadata that is removed from the buffer.

33. The method of claim 32, further comprising the steps of receiving a control signal after the trigger condition is detected, said control signal being generated in response to a user input, and entering metadata from memory into the buffer in response to the control signal so that an image can be recorded.

34. The method of claim 32, further comprising the steps of receiving a control signal before the trigger condition is detected, said control signal being generated in response to a user input, and entering metadata from memory into the buffer in response to the control signal so that an image can be recorded.

35. The method of claim 31, wherein the step of recording an image comprises capturing an image, associating the image and the metadata that is stored in the buffer and storing the image and the metadata.

36. The method of claim 31, wherein the step of recording an image comprises the steps of associating the image with the metadata that is stored in the buffer, and storing the image and metadata separately.

37. The method of claim 31, wherein the step of recording an image comprises capturing an image in response to each trigger signal, and wherein the step of recording an image comprises the step of storing the captured image only when both of a manual metadata input action and separate trigger condition are detected that uniquely correspond the image.
